(19) United States
(12) Patent Application Publication
(10) Pub. No.: US 2022/0321619 A1
(43) Pub. Date: Oct. 6, 2022

(54) SYSTEMS AND METHODS FOR ELECTRONIC NOTETAKING AND CALLING INTO ELECTRONIC MEETINGS

(71) Applicant: Salesloft, Inc., Atlanta, GA (US)

(72) Inventors: Austin Michael Brown, Apex, NC (US); Matthew Irish Finneran, Apex, NC (US)

(73) Assignee: Salesloft, Inc., Atlanta, GA (US)

(21) Appl. No.: 17/845,857

(22) Filed: Jun. 21, 2022

Related U.S. Application Data
(63) Continuation-in-part of application No. 16/855,610, filed on Apr. 22, 2020.
Application No. 16/855,610 is a continuation of application No. 16/524,653, filed on Jul. 29, 2019, now Pat. No. 10,742,695.
Application No. 16/524,653 is a continuation-in-part of application No. 17/206,916, filed on Mar. 19, 2021.
Application No. 17/206,916 is a continuation of application No. 16/518,367, filed on Jul. 22, 2019, now Pat. No. 11,115,624.
(60) Provisional application No. 62/713,281, filed on Aug. 1, 2018.

(51) Int. Cl. H04L 65/403; H04L 67/02; H04L 51/02

(52) U.S. Cl. CPC H04L 65/403; H04L 67/02; H04L 51/02; G06F 40/205

(57) ABSTRACT

Methods and systems for calling into electronic conference system meetings is disclosed. Methods and systems for recording information related to an electronic conference system meeting is also disclosed.

### CROSS-REFERENCE TO RELATED APPLICATIONS

The present application is a continuation-in-part to U.S. application Ser. No. 16/855,610 filed on Apr. 22, 2020, which is a continuation of U.S. application Ser. No. 16/524,653 filed on Jul. 29, 2019, which claims priority to U.S. provisional Ser. No. 62/713,281, filed on Aug. 1, 2018. The present application is also a continuation-in-part to U.S. application Ser. No. 17/206,916 filed on Mar. 19, 2021, which is a continuation to U.S. application Ser. No. 16/518,367 filed on Jul. 22, 2019. All of the foregoing are incorporated herein by reference in their entireties.

### SYSTEMS AND METHODS FOR ELECTRONIC NOTETAKING

### BRIEF DESCRIPTION OF THE FIGURES

FIG. 1 illustrates a screen shot showing a main screen, according to an embodiment.

FIG. 2 illustrates a meeting intelligence screen shot, according to an embodiment.

FIG. 3 illustrates an add bot screen where a meeting ID is entered, according to an embodiment.

FIG. 4 illustrates an add bot screen where a URL is entered, according to an embodiment.

FIG. 5 illustrates how to indicate that a bot is “attending” and recording the meeting, according to an embodiment.

FIG. 6 illustrates a system diagram, according to an embodiment.

### DETAILED DESCRIPTION OF EMBODIMENTS OF THE INVENTION

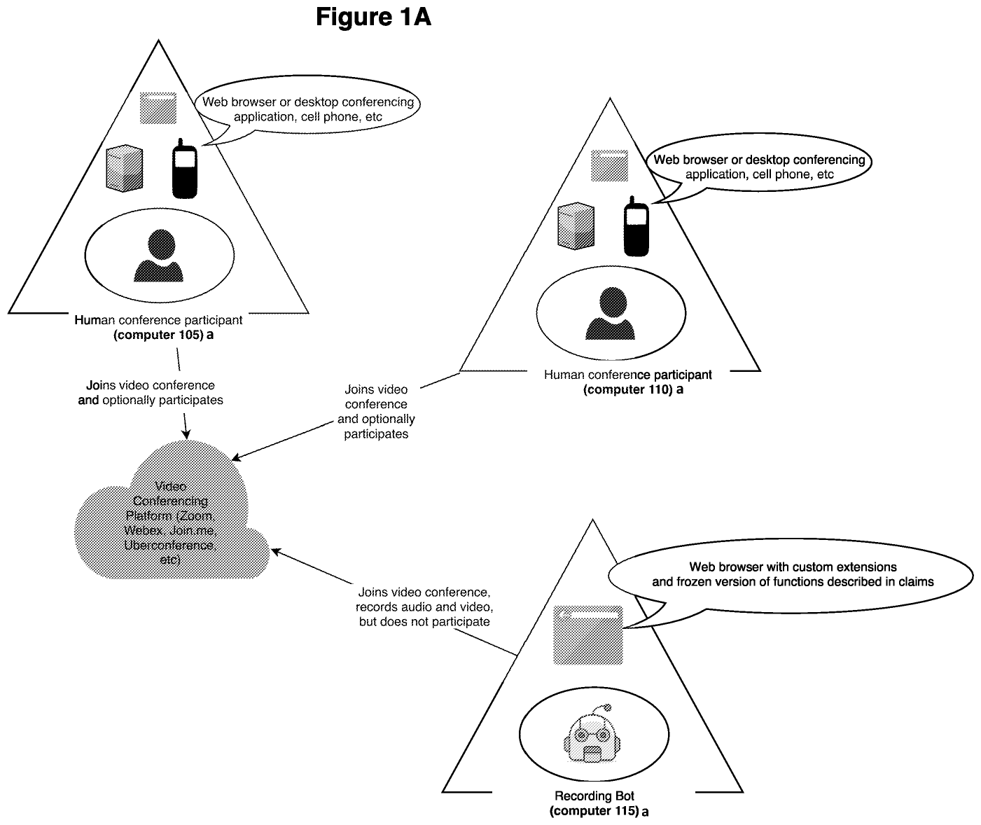

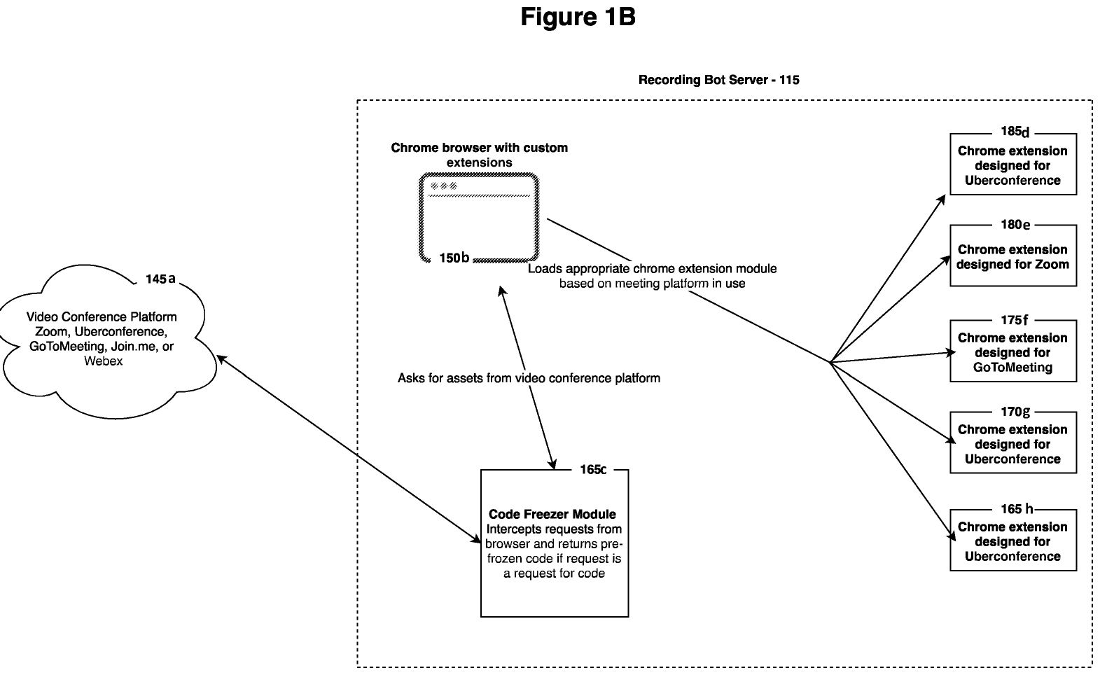

FIG. 1 illustrates a screen shot showing a main screen 100, according to an embodiment. A live notes section 105 can be displayed where a user (e.g., Matt) can enter in notes while in an electronic conference system meeting (e.g., a phone meeting or an in-person meeting) is taking place. The time into the meeting is displayed along with the note created by the user at that time. A meeting summary section 110 can display information about the meeting, such as call duration (e.g., 1:12), the organizer (e.g., Matt), and the platform (e.g., ZOOM). In some embodiments, any or all of the following platforms can be supported: WEBEX, ZOOM, GOTOMEETING, UBERCONFERENCE, JOIN.ME. Those of ordinary skill will see that any other current conferencing platform or any future conferencing platform can also be used.

A currently viewing section 115 can comprise the participants (e.g., Matt, Abby, Ryland). A tag section 120 can comprise any or all of the following tags which can enable a participant to tag the meeting: Budget, Negotiation, Pricing, Intro, Next Steps, Objection, Needs, Business, Outcome, Timing, and Authority. A tag (also called “comment tag”) can be pinned to an exact moment of its creation (or a moment before its creation) within the context of the recording of the meeting and designated by the user (e.g., related to Budget, related to Pricing) so that the user can easily go back and access or replay any tagged portions of the meeting. Those of ordinary skill in the art will see that any other type of meeting tag can be created.

To create a tag, a comment tag category that can later be associated to a specific comment tag can be created, as show in the following example code:

```
// DB library syntax inspired by knex.js database connection library
const sql = \grave{ }
  insert into main.comment_tags (organization_id, tag_name)
  values(:organizationId, :tagName)
  returning id
\grave{ };
let bindParams = {
  organizationId,
  tagName
};
const conn = db.getConnection( );
const newCommentTags = await conn.raw(sql, bindParams);
const {id: newTagId} = newCommentTags.rows[0];
```

A comment tag with a category id associated to it can then be inserted, as illustrated in the following example code (e.g., where the timestamp is for 10 seconds ago):

// DB library syntax inspired by knex.js database connection library
// next, using the newTagId created in the snippet above
conn(‘comment’).insert({ text: /* comment text */ ‘’,
created_at_in_milliseconds: Date.now( ) -
(10 * 1000), tag_{—}id: newTagId})

As mentioned above, when a comment tag is created, the date can be moved to a certain time period before the comment tag is created so that the beginning of the important information is captured. This time period can be 1 second-25 seconds, or even longer. The above example code uses an example of saving a comment with a date of 10 seconds ago. In some embodiment, a user can designate a certain time period for each of the comment tags (e.g., all tags can go back 3 seconds, or the Pricing tag can go back 2 seconds, but a Budget tag can go back 10 seconds)

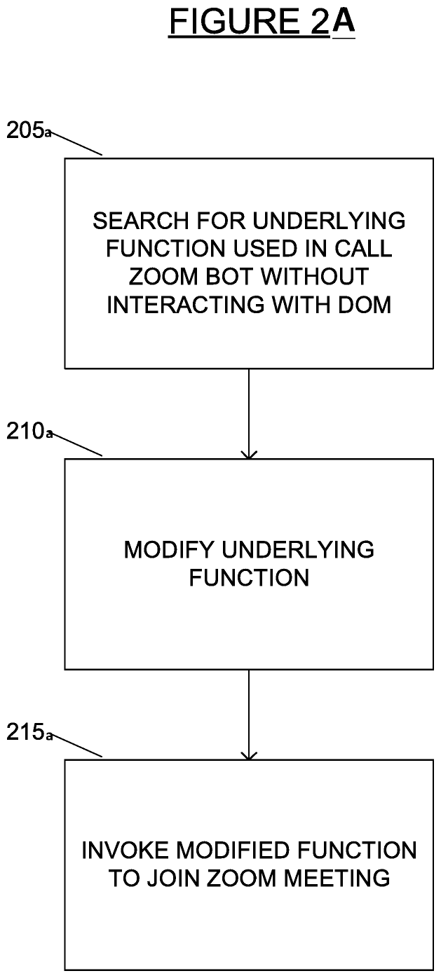

FIG. 2 illustrates a meeting intelligence screen shot 200, according to an embodiment. Several types of meeting information can be accessed. The in-progress screen 225 can show notes from in-progress meetings. A search box can be provided in 230, with tabs where the user can filter the content that is searched. The search tabs can comprise: all 235, comments 240, and title 245. In each in-progress meeting summary that is shown in 225, the following information can be shown: details (date, time, duration), organizer, platform, shared, invitees, attendees, other participants, comments from participants, or comment tags, or any combination thereof.

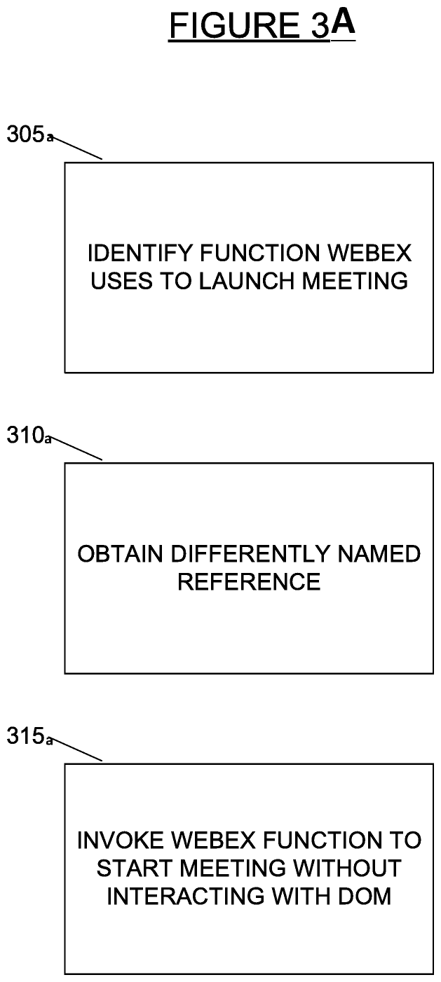

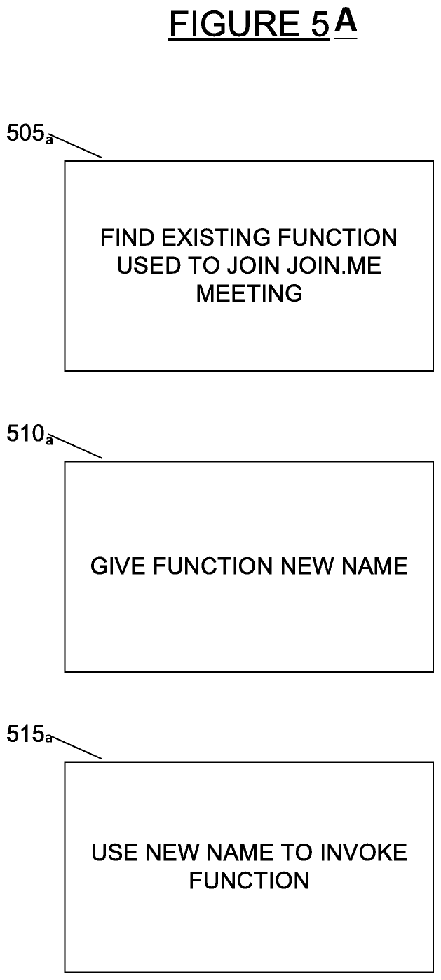

FIG. 3 illustrates a screen shot showing an add bot screen 300, according to an embodiment. When a bot is added, this means that a virtual participant (e.g., that is recording the call) is present. For example, FIG. 5 illustrates how to indicate that a bot is “attending” and recording the meeting. In the top right corner of FIG. 5, an icon appears showing NOTENINJA to be a participant. This indicates that the meeting is being recorded by the bot.

A meeting platform section 305 can allow a user to enter in a platform (e.g., ZOOM) for the bot, A meeting title section 310 can allow a user to enter in a title for the meeting (e.g., “meeting with customer”). A meeting ID or URL section 315 can allow the user to enter in the meeting ID or URL. The pseudo-code below illustrates an example of how a bot can join a meeting by URL. The code below illustrates how the URL the user provides is parsed in order to find details about the meeting required to join the meeting (e.g., the meeting ID) from the URL (in this example a UBERCONFERENCE platform is used, although any platform can be used):

const userinput =
‘https://uberconference.com/personal_meeting_example_id’;
const regex = /uberconference\.com\/([a-z0-9-_.]+)/i;
const matches = userInput.match(regex);
const meetingId = matches[1];

Any URL can be parsed to find the meeting ID. For example, the following types of URLs can be parsed:
https://global.gotomeeting.com/join/456684725
https://app.gotomeeting.com/123456789
https://www.gotomeeting.com/join/138906133
https://www.gotomeet.me/RickSanchezz685
https://zoom.us/j/561755827
https://examplecompanydomain.zoom.us/my/examplepersonatcompany
https://www.uberconference.com/mattnoteninja123_-_-
https://join.me/996-967-779
https://join.me/austin609
https://austinboondockcities.my.webex.com/join/austin

The code below illustrates how the meeting ID can be used to join a meeting in a web browser (using, for example, nodejs webdriver bindings for a browser):

const driver=new webdriver.Builder( )build( );
const url=‘https://www.uberconference.com/{meetingId}’;
console.log(‘LOG: doing ${meetingPlatform} url: ${url}’);
driver.get(‘https://www.uberconference.com/${meetingId}’);

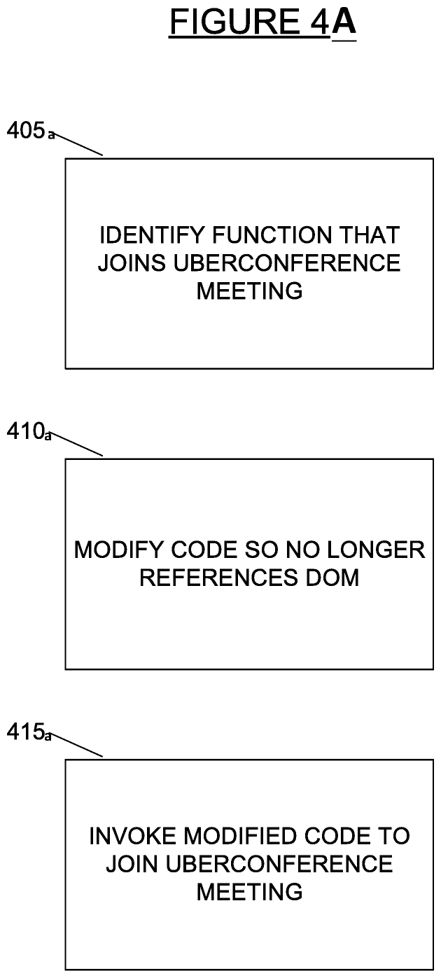

FIG. 3 illustrates an add bot screen where a meeting ID is entered, and FIG. 4 illustrates an add bot screen where a URL is entered.

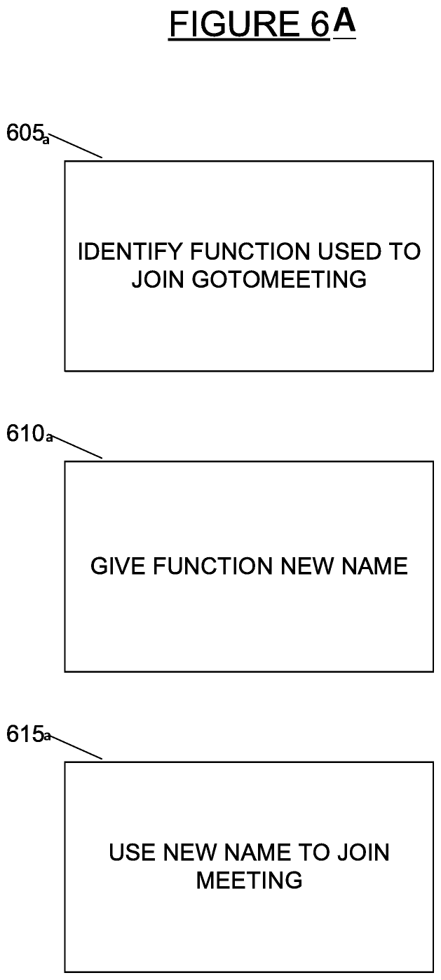

FIG. 6 illustrates a system diagram, according to an embodiment. A virtual assistant bot 605 can record any meeting that uses an electronic conference system meeting. A user's computer 610 (e.g., a SALESLOFT user using a SALESLOFT web application) can have installed or otherwise access a comment tag module 615 and an add recording bot module 620. Those of ordinary skill in the art will recognize that a user can be: a sales manager, an administrator, or a participant in the electronic conference system meeting, or any other person or entity that interacts with the system. The comment tag module can enable adding and using comment tags, as descried above. The add recording bot module can enable adding a virtual participant bot to record the meeting. The electronic conferencing system 620 can be a connector that ties the user to the meeting and also ties the virtual assistant bot to the meeting.

### METHODS AND SYSTEMS FOR CALLING INTO MEETINGS

### BRIEF DESCRIPTION OF DRAWINGS

FIG. 1A illustrates a system for calling into a video conference (e.g., meeting) without interacting with a user interface element, according to an embodiment.

FIG. 1B also illustrates a system for calling into a video conference (e.g., meeting) without interacting with a user interface element, according to an embodiment.

FIG. 2A illustrates calling into a Zoom meeting, according to an embodiment.

FIG. 3A illustrates calling into a WebEx meeting, according to an embodiment.

FIG. 4A illustrates calling into an UberConference meeting, according to an embodiment.

FIG. 5A illustrates calling into a Join.me meeting, according to an embodiment.

FIG. 6A illustrates calling into a GoToMeeting, according to an embodiment.

### DESCRIPTION OF EMBODIMENTS OF THE INVENTION

FIGS. 1A-1B illustrate a system for calling into a video conference (e.g., meeting) without interacting with a user interface element (e.g., a document object model (DOM), a graphical user interface (GUI), a user interface (UI)), according to an embodiment. The video conference can be joined using, for example, the Internet or an Intranet. The DOM can be an application programming interface (API) (e.g., the graphical user interface (GUI). It can define the logical structure of documents and the way a document is accessed and manipulated. The video conference can be called without interacting with the DOM (or GUI, or UI) by, for example, entering meeting details (e.g., the name of the bot, the meeting ID), clicking buttons to activate the session, etc.). The system can be used with previously existing code (e.g., see the examples of FIGS. 2A and 4A below, where Zoom and UberConference are used) or newly incorporated code (e.g., see the examples of FIGS. 3A, 5A and 6A below, where WebEx, Join.me, and GoToMeeting are used).

In FIG. 1A, a human conference participant computer 105 can join the video conference and optionally participate. The human conference participant computer 105 can use a Web browser, desktop conferencing application, cell phone, etc. A human conference host computer 110a can join the video conference and optionally participate. The human conference host computer 110a can use a Web browser, desktop conferencing application, cell phone, etc. A recording bot server 115a can join the video conference, and record the audio and/or video, but not participate. The recording bot server 115a can use a Web browser with custom extensions and a frozen version of the functions referenced in FIGS. 2A-6A below.

In FIG. 1B, the recording bot server 115a can initiate a Chrome browser 150a with a custom extension designed for a particular video conference platform 155a (e.g., for WebEx, Join.me, GoToMeeting, Zoom, UberConference). The appropriate Chrome extension module can be loaded based on the meeting platform in use. The Chrome browser 150a can request a connection to the video conference platform. In some embodiments, rather than have the video conference platform provide the Chrome browser 150a with its version of code, a code freezer module 160a can intercept some of the requests for code that the video conference platform would return and instead return a frozen version of code that includes either modified versions of the code, or versions of code that expose certain underlying functions, as described in detail in FIGS. 2A-6A. Upon receiving the frozen code, the Chrome browser 150a can initiate custom-designed Chrome extensions (e.g., WebEx Chrome extension 165a, Join.me Chrome extension 170a, GoToMeeting Chrome extension 175a, Zoom Chrome extension 180a, UberConference Chrome extension 185a) that can interact with the frozen code in order to record the meeting.

FIGS. 2A-6A illustrates example methods for calling into a meeting without interacting with the DOM. FIG. 2A references calling into a Zoom meeting, according to an embodiment. FIG. 3A references calling into a WebEx meeting, according to an embodiment. FIG. 4A references calling into an UberConference meeting, according to an embodiment. FIG. 5A references calling into a Join.me meeting, according to an embodiment. FIG. 4A references calling into a GoToMeeting, according to an embodiment.

With respect to the Zoom meeting in FIG. 2A, In 205a, a search can be performed for an underlying function that is used to call the bot directly without interacting with the DOM itself. For example, an existing function that is normally used to start the meeting can be found. In one embodiment, the function can reference the DOM (or GUI) as follows:

function formSubmit( ) {
var confNo = Trim($(‘#join-confno’).val( ));
var username =$(‘#join-username’).val( );
}

In 210a, the found underlying function can be modified so that it takes parameters instead of referencing the DOM (or GUI). For example, the following can be used instead of the two lines above in bold that reference the DOM:

function formSubmit(confNo, userName)

In 215a, the modified function can be invoked with values obtained from our system instead of from the DOM (or GUI) in order to join the meeting bot. For example:

joinmeeting.formSubmit(callInNumber, botName)

With respect to the WebEx meeting in FIG. 3A, in 305a, a function that WebEx uses to launch a meeting is identified:

```
function _getLaunchCalendarMeetingFunc( ) {
  const elem = document.querySelector(“.meeting-join”)
  return elem &&
  elem._vue_ &&
  typeof elem._vue_.smartLaunchMeeting === ‘function’ &&
  elem._vue_.smartLaunchMeeting
}
```

In 310a, a differently named reference to Webex's smartLaunchMeeting function can be obtained:

const launchCalendarMeetingFunc=_getLaunchCalendarMeetingFunc( );

In 315a, Webex's smartLaunchMeeting function can be invoked to start the meeting without interacting with the GUI (e.g., clicking any buttons):

launchCalendarMeetingFunc(‘thinclientjoin’);

With respect to the UberConference meeting in FIG. 4A, in 405a, the function that causes the page to join the meeting can be identified:

```
const obj = {
  _next: function(n) {
  // ...
  , u = r.name.$el.val( )
  , d = r.name.$el.val( )
  // ...
  }
}
```

In 410a, the code can be modified so that it no longer references the GUI. For example, see how the code in bold changes from the code illustrated for 405a:

```
const obj = {
  _next: function(n) {
  // ...
  , u = _{—}botName
  , u = _{—}botEmail
// ...
  }
}
```

In 415a, the modified code can be invoked to launch the UberConference meeting:

this._next( )

With respect to the to the Join.me meeting in FIG. 5A, in 505a, an existing function that is called in the normal flow of a user joining the meeting is located. For example, the following function can be found:

function ( ) {
e.$broadcast(“Visitor.Join”, t.visitorNameCtrl.visitorName)
}

In 510a, the function is given a new (e.g., global) name so that it can be referenced in a later window. For example:

JOINME_LOGIN_ = function ( ) {
e.$broadcast(“Visitor.Join”, t.visitorNameCtrl.visitorName)
}

In 515a, the new reference can be used to invoke the underlying function in a later window. For example:

JOINME_LOGIN_( )

With respect to the GoToMeeting in FIG. 6A, in 605, an existing function that is called in the normal flow of a user joining a meeting can be located. For example:

function ( ) {e.submit( )}

In 610, the function is given a new (e.g., global) name so that it can be referenced in a later window. For example:

submitMyForm=function ( ) {e.submit( )}

In 615a, the new reference can be used to invoke the underlying function in a later window. For example:

submitMyForm( )

### CONCLUSION

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown. For example, the steps and/or limitations may be performed in a different order then that shown in the specification and/or claims.

Although the term “at least one” may often be used in the specification, claims and drawings, the terms “a”, “an”, “the”, “said”, etc. also signify “at least one” or “the at least one” in the specification, claims and drawings.

Additionally, the terms “including”, “comprising” or similar terms in the specification, claims and drawings should be interpreted as meaning “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

1. A method for joining a video conference, comprising:
finding a first function used by a recording bot to join a video conference;
replacing the first function with a second function; and
using the second function to join the video conference.

2. A method of enabling a user to direct a virtual participant bot to join an electronic conference system meeting:
accepting a URL from the user using a record created on a server, wherein the user is a participant in the electronic conference system meeting;
parsing the URL in order to gather meeting details required to join the electronic conference system meeting using the record;
using the meeting details to enable a virtual participant bot to join the electronic conference system meeting in order to record electronic information streams related to the electronic conference system meeting;
recording the electronic conference system meeting by the virtual participant bot; and
indicating that the virtual participant bot is recording the electronic conference systems meeting.

3. The method of claim 2, wherein the meeting details comprise the meeting ID, and the meeting ID is used to enable the virtual participant bot to join.

4. The method of claim 2, wherein the user comprises an administrator and/or a sales manager.
